(19) United States
(12) Patent Application Publication
(10) Pub. No.: US 2002/0185764 A1
(43) Pub. Date: Dec. 12, 2002

(54) Vacuum detection apparatus and method

(76) Inventor: Stephen R. Griggs, Freedom Township, OH (US)

Correspondence Address: Frank C. Manak III, Suite L 7, 110 West Streetsboro Street, Hudson, OH, 44236, US

(21) Appl. No.: 09/879,760

(22) Filed: Jun. 12, 2001

(51) Int. Cl. B29C 43/58

(52) U.S. Cl. 264/39; 264/40.1; 425/149

(57) ABSTRACT

A vacuum apparatus and method for detecting the presence of a workpiece on a machine employs a mount for holding a workpiece that has an internal passageway extending between a surface of the mount designed for contact with the workpiece and a surface of the mount designed to be free of contact with the workpiece. A vacuum pumping and sensing apparatus is connected to the end of this passageway at the external surface of the mount and this apparatus has a sensor that senses the pressure in the passageway in the mount. The apparatus and method also employ a control device connected to the vacuum pumping and sensing apparatus for stopping the operation of the machine when the sensor senses a pressure above a predetermined maximum pressure.

### FIELD OF THE INVENTION

This invention relates generally to systems for detecting the presence of workpieces on machines, such as a part to be formed by a stamping press or an insert to be applied to a molded part during a molding process. More particularly, it relates to a system that detects the presence of such a workpiece by means of a vacuum.

### BACKGROUND OF THE INVENTION

In the operation of stamping presses and machines that form molded products having inserts, great care must be taken to insure that the workpiece to be stamped or inserted is in its proper place in the machine before the machine is operated to make the product. Otherwise, the finished product will be defective.

Human operators and inspectors are often employed to make such that such workpieces are properly placed. Unfortunately, their inspections are subject to human error, and other laborers must be employed to inspect the finished products and to discard products that were not properly formed.

To reduce and perhaps eliminate the need for such human inspection, various scanning devices are often used, such as the photocell sensor 31 of the molding apparatus disclosed in U.S. Pat. No. 4,140,451. Such scanning devices, however, are expensive and cumbersome. It is often not feasible to locate them in places where they can operate reliably.

Fluidic sensing devices that use pressurized fluids have also been used to detect the presence of parts in molding machines. Examples of such sensing devices are shown in U.S. Pat. Nos. 3,677,680 and 3,719,396. These sensing devices are also expensive because they rely on the use of sophisticated fluidic logic devices.

The present invention resides in a much simpler detection system that uses a vacuum to detect the presence of the workpiece. In the past vacuum systems have been used to hold workpieces in place while they are being formed in molds, for example, those shown in the above-mentioned U.S. Pat. Nos. 3,677,680 and 3,719,396, as well as U.S. Pat. Nos. 5,494,615 and 5,614 146. However, none of these vacuum systems detect the presence of the workpiece so that appropriate action can be taken if the workpiece is not in its proper position. In fact, in the mold presses of U.S. Pat. Nos. 3,677,680 and 3,719,396, a separate, pressurized fluidic sensing system is used to detect the presence of the workpiece, in addition to the vacuum system that holds the workpiece in place.

### SUMMARY OF THE INVENTION

An object of the present invention is to provide a new system for detecting the presence of workpiece on a machine that is reliable, simple and economical.

This and other objects are accomplished by a vacuum system that comprises a mount for holding a workpiece on a machine that has an internal passageway extending between a surface of the mount designed for contact with the workpiece and a surface of the mount designed to be free of contact with the workpiece. A vacuum pumping and sensing apparatus is connected to the end of this passageway at the external surface of the mount and this apparatus has a sensor that senses the pressure in the passageway in the mount. The system also includes a control device connected to the vacuum pumping and sensing apparatus for stopping the operation of the machine or for taking other appropriate action when the sensor senses a pressure above a predetermined maximum pressure.

### BRIEF DESCRIPTION OF THE DRAWINGS

FIG. 1 is a schematic plan view of a vacuum sensing system illustrating one embodiment of present invention designed for use in a mold press; and

FIG. 2 is a schematic plan view of a vacuum sensing system illustrating another embodiment of the present invention designed for use in a stamping press.

### DETAILED DESCRIPTION OF THE INVENTION

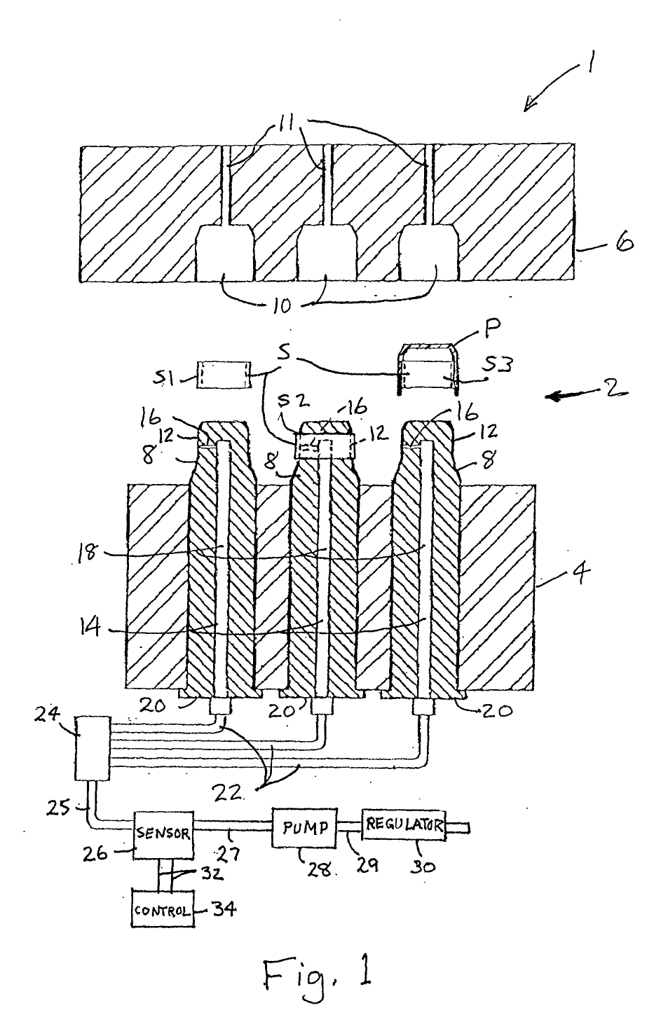

In the embodiment shown in FIG. 1, a vacuum system 1 is connected to a mold press 2 that has two steel plates 4 and 6. Mandrels 8, are mounted in the plate 4 are designed to hold inserts S that are to be formed as an integral part of a molded product.

The plate 6 has mold cavities 10 and passageways 11. When the plates 4 and 6 are pressed together, a molding compound is introduced through the passageways 11 to fill the cavities 10 and form molded products having inserts S. Insert S1 on the left side of the press 2 is shown in a position prior to its placement on the mandrel 8. Insert S2 in the center is shown in its proper place on the mandrel 8, ready for the mold press 2 to close. The final product P on the left side of the press 2 is shown formed with an insert S3 after the end of molding process.

Mandrels 8 have outer surfaces 12 designed for sliding contact with an insert S. The mandrels are drilled with passageways 14, each having a radial portion 16 extending from the outer surface 12 and an axial portion 18 extending from the radially inward end of the portion 16 to an external end 20 of the mandrel 8. It is important that each passageway 14 has one end opening to a mandrel surface that is in contact with a sleeve S when it is properly positioned on the mandrel and another end opening to a mandrel surface that is free from contact with the insert S when it is positioned on the mandrel.

Hoses 22 connect the passageways 14 to a manifold 24, which is in turn connected by a hose 25 to a vacuum sensor 26. A hose 27 connects the vacuum sensor 26 to a vacuum pump 28. A venturi type pump is recommended for the vacuum pump 28, which operates by drawing in air through an inlet 29 and pumping it into a venturi that generates a vacuum in hoses 22, 25 and 27 and passageways 14. An optional regulator 30 may be attached to the inlet 29 to control the amount of air flowing into the venturi of pump 28.

The vacuum sensor 26 monitors the vacuum pressure drawn by the pump 28. The sensor 26 is electrically connected by wires 32 to a vacuum system control 34. The vacuum system control 34 is electrically connected to the controls that operate the mold press 2.

The vacuum pump 28, vacuum sensor 26, regulator 30 and vacuum system control 34 are standard, commercially available items of equipment. A recommended vacuum pump 28 is an air-driven, single-stage, fixed flow McMaster pump, Model 41605ki4, which requires no regulator 30. A Keyance vacuum sensor, model AP30, is recommended for the sensor 26, and a Keyance PLC control, Model KV16AR, is recommended for the vacuum system control 34.

The vacuum system 1 of FIG. 1 operates as follows:

1) A vacuum drawn by the vacuum pump 28 determines the presence of inserts S on each of the mandrels 8.

2) If all the inserts S are properly positioned on the mandrels 8, the vacuum sensor 26 detects a vacuum pressure in the passageways 14 at or below a predetermined pressure.

3) If such a vacuum pressure is detected, relays in the vacuum system control 34 allow the mold press 2 to operate. If such a pressure is not detected, the relays will not operate and neither will the mold press 2.

4) When the mold press 2 has completed its operating cycle, the vacuum sensor 26 detects a vacuum pressure above the predetermined pressure, indicating that the finished products P has been removed from the mandrels 8.

5) The vacuum pump 28 may be a reversible pump that can be used to supply air pressure to the passageways 14. If this is the case, the vacuum system control 34 may be configured so that the vacuum pump 28 reverses its direction at a predetermined time after step 4) is completed, causing pressurized air to clean debris from passageways 14 and the outer surfaces 12 of the mandrels 8.

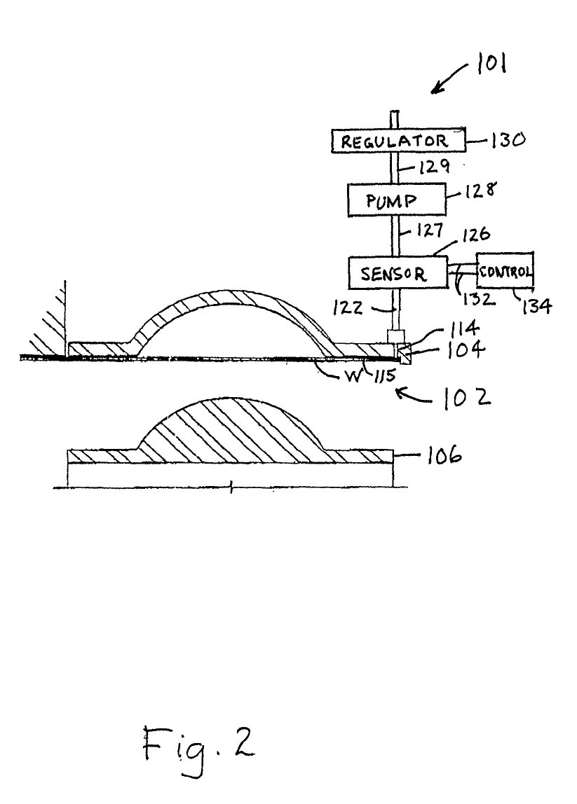

The vacuum system 101 of the embodiment shown in FIG. 2 is connected to a stamping press 102 that is designed to form a flat workpiece W into a dome-shaped final product. The press 102 consists of two plates 104 and 106. The plate 104 is designed to hold the workpiece W during the stamping operation.

A passageway 114 in the plate 104 has one end at surface 115 of plate 104 in contact with the workpiece W and its other end connected to a hose 122 connected to a vacuum sensor 126. The sensor 126 is connected by a hose 127 to a vacuum pump 128. Again, a venturi type pump is recommended for the vacuum pump 128. An optional regulator 130 may be attached to the inlet 129 to control the amount of air flowing into the venturi of pump 128.

The vacuum sensor 126 monitors the vacuum pressure drawn by the pump 128. The sensor 126 is electrically connected by wires 132 to a vacuum system control 134. The vacuum system control 134 is electrically connected to the controls that operate the stamping press 102.

The vacuum pump 128, vacuum sensor 126, regulator 130 and vacuum system control 134 are standard, commercially available items of equipment and the same models recommended for the mold press 2 of FIG. 1 may be used for the stamping press 102 of FIG. 2.

The vacuum system 101 operates in exactly the same manner as the vacuum system 1 of FIG. 1 to insure that a workpiece W is always in its proper position on the plate 104 prior to operation of the mold press 2.

One advantage of using a vacuum system to determine the presence of a workpiece in a press is that the press may be positioned to operate either vertically as shown in FIGS. 1 and 2, or horizontally. If the press is operated horizontally, the vacuum pressure may be adjusted to provide a sufficient pull on the workpiece to insure that it does not fall off the press prior to the formation of the finished product.

The vacuum apparatus and method shown in FIGS. 1 and 2 thus provide a reliable, simple and economical way of monitoring the presence of workpieces on machinery. The mold press of FIG. 1 and the stamping press of FIG. 2 are only examples of many kinds of machinery with which this apparatus and method may be used.

While several embodiments of the present invention have been shown and described, other embodiments, modifications and additions will of course be apparent to those skilled in the art, while remaining within the scope of the appended claims.

1. Apparatus for detecting the presence of a workpiece on a machine, comprising:
(a) a mount for holding the workpiece on the machine, said mount having a contact surface designed for contact with the workpiece, an external surface designed to be free of contact with the workpiece and an internal passageway extending between said surfaces;
(b) a vacuum pumping and sensing apparatus connected to the end of said passageway at the external surface of the mount, said apparatus having a sensor that senses the pressure in said passageway; and
(c) a control device connected to said vacuum pumping and sensing apparatus for stopping the operation of said machine or for taking other appropriate action when said sensor senses a pressure above a predetermined maximum pressure.

2. Apparatus for detecting the presence of a workpiece on a machine according to claim 1 wherein the machine is a stamping press, the workpiece has a tubular shape, the mount is a mandrel having a substantially cylindrical surface designed for sliding contact with the workpiece and the passageway in the mount has a first portion that extends radially inwardly from said cylindrical surface and a second portion that extends axially of the mandrel from the radially inward end of said first portion to an external end of the mandrel that is designed to be free of contact with the workpiece.

3. Apparatus for detecting the presence of a workpiece on a machine according to claim 1 wherein the machine is a mold press, the workpiece is an insert to be applied to the molded product during the molding process, the mount is a part of the mold press that also holds the insert in its proper place during the molding process and the passageway in the mount extends from a surface of the mount in contact with the insert to an external surface that is designed to be free of contact with the insert.

4. A method of detecting the presence of a workpiece on a machine mount, comprising the steps of:
(a) placing a workpiece on the mount,
(b) drawing a vacuum through a passageway in the mount,
(c) measuring the pressure in the passageway,
(d) allowing the machine to operate on the workpiece when said pressure is below a predetermined maximum pressure, and
(e) preventing the machine from operating when said pressure is above a predetermined maximum pressure.

5. The method of detecting the presence of a workpiece on a machine mount according to claim 4, comprising also the step forcing pressurized air through said passage after said machine has completed its operation on the workpiece, to clean debris from the passageway surfaces and other surfaces of the mount.
